(19) United States
(12) Patent Application Publication
(10) Pub. No.: US 2005/0129455 A1
(43) Pub. Date: Jun. 16, 2005

(54) Applicator device for cosmetic products

(75) Inventor: Nadia Avalle, Vallese (CH)

Correspondence Address: AKERMAN SENTERFITT, P.O. BOX 3188, WEST PALM BEACH, FL, 33402-3188, US

(73) Assignee: Intercos S.p.A., Milano (IT)

(21) Appl. No.: 11/005,347

(22) Filed: Dec. 6, 2004

(30) Foreign Application Priority Data
Dec. 12, 2003 (IT) MI2003U000584

(51) Int. Cl. B43K 5/00; B43M 11/06; A47L 13/30

(52) U.S. Cl. 401/266; 401/265; 401/263

(57) ABSTRACT

The present invention concerns an applicator device for cosmetic products, in particular for the face, as for instance foundation cream. In an embodiment thereof the applicator device for cosmetic products comprises: a container containing a cosmetic product; means for the advancement of said cosmetic product toward a first end of said container, placed at a second end of said container; a cap suitable to close said first end of said container; characterised in that said first end comprises a grid, from which said cosmetic product outflows, whose external surface has undergone a flocking process.

The present invention concerns an applicator device for cosmetic products, in particular for the face, as for instance foundation cream. The device is in particular in the shape of stick.

Cosmetic products of creamy type for face are contained in containers from which it is possible to use the product by getting it by means of opportune applicators or directly by the hands.

Cosmetic products of semi-solid type for face are contained in appropriate containers which in some cases can also function as applicator.

Cosmetic products of the creamy type (fluid or semi-fluid) can be considered to be better than solid or semi-solid type since they allow to obtain benefits both on the intrinsic characteristics of the product itself as for instance a greater homogeneity of the components which form the product, as well as on the applicative characteristics of the product as for example a greater facility of dispersion on the face, and they also have a more uniform appearance.

However, during the application of creamy cosmetic products, even with the use of opportune applicators, it is possible to get dirty thus making their use difficult and unpleasant.

In view of the state of the art herein described, object of the present invention is to provide an applicator device for cosmetic products that is capable to dispense cosmetic product of the fluid or semi-fluid type without soiling and that is easy to utilise.

According to the invention, such object is attained by means of a device applicator for cosmetic products comprising: a container containing a cosmetic product; means for the advancement of said cosmetic product toward a first end of said container, placed at a second end of said container; a cap suitable to close said first end of said container; characterised in that said first end comprises a grid, from which said cosmetic product exits, whose external surface was subjected to a flocking process.

Owing to the present invention it is possible to provide an applicator device for cosmetic products that can use very performing creamy cosmetic products. The grid for the output of the cosmetic product covered with flock behaves as a cap for the cosmetic product which can advance only if thrust by the advancement means. Besides, the flocking confers a contact surface which is velvety and soft to the touch. In addition, the advancement means allow only the advance of the thrust piston and not its backing, therefore the product is always ready for use, and its exit is continuous and uniform. The presence of an airtight cap prevents the evaporation of volatile elements present in the product, which remains integral and lasts longer.

The characteristics and the advantages of the present invention will become evident from the following detailed description of an embodiment thereof, which is illustrated as a non limiting example in the enclosed drawings, in which:

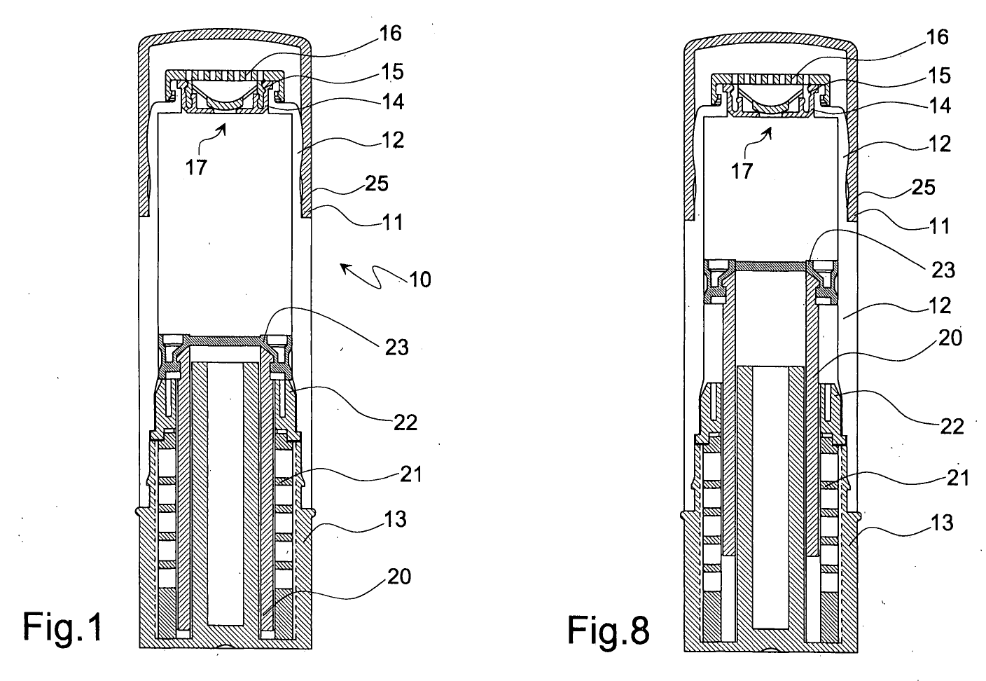

FIG. 1 shows an applicator device for cosmetic products in section;

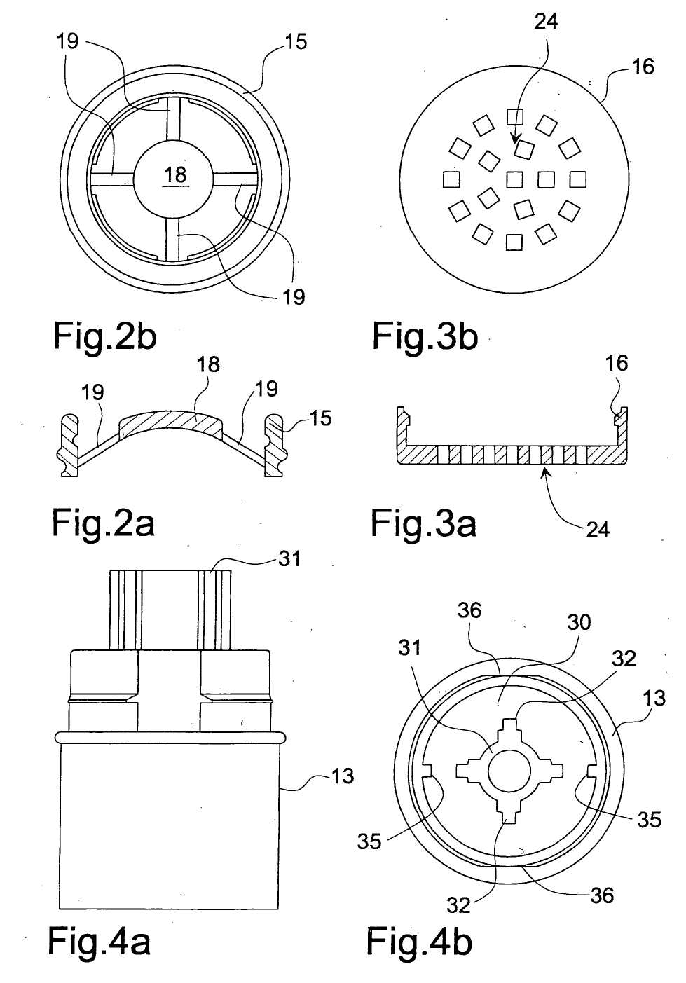

FIG. 2a shows a sectional front view of a sleeve of the applicator device for cosmetic products;

FIG. 2b shows a top view of a sleeve of the applicator device for cosmetic products;

FIG. 3a shows a sectional front view of an output sleeve of the applicator device for cosmetic products;

FIG. 3b shows a top view of an output sleeve of the applicator device for cosmetic products;

FIG. 4a shows a front view of a closing element of the applicator device for cosmetic products;

FIG. 4b shows a top view of a closing element of the applicator device for cosmetic products;

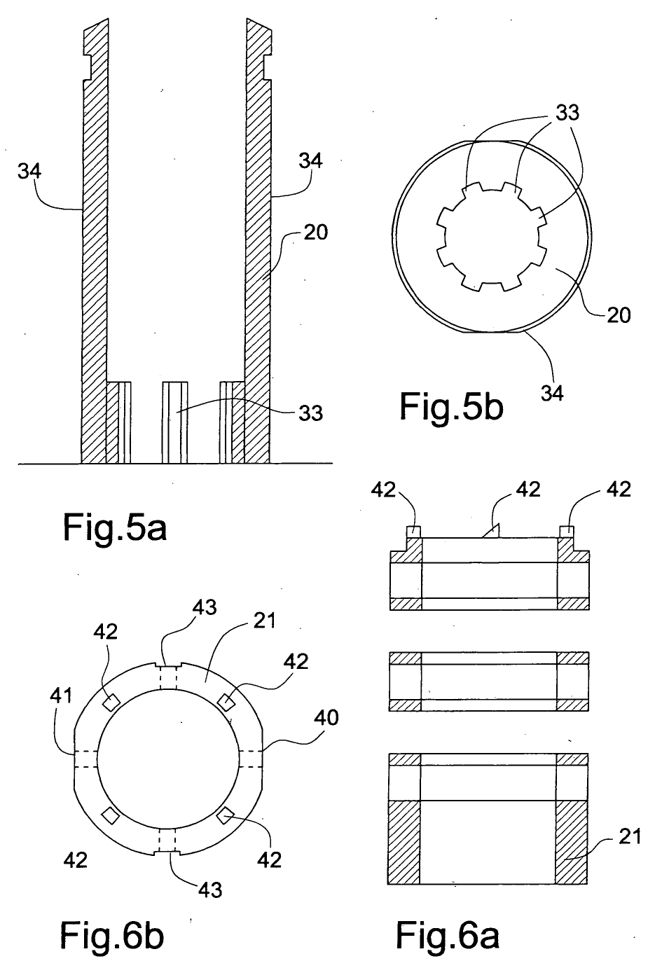

FIG. 5a shows a front view of a tubular element of the applicator device for cosmetic products;

FIG. 5b shows a top view of a tubular element of the applicator device for cosmetic products;

FIG. 6a shows a front section view of a round structure internal to the applicator device for cosmetic products;

FIG. 6b shows a top view of a round structure internal to the applicator device for cosmetic products;

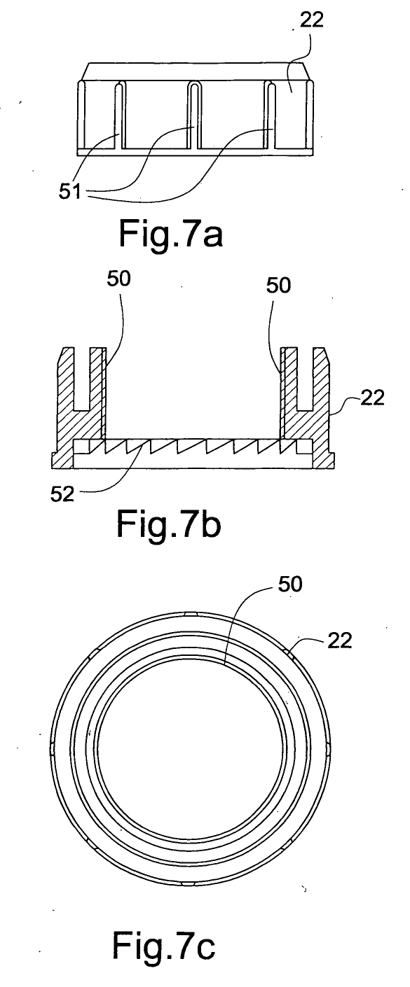

FIG. 7a shows a front view of a ring gear of the applicator device for cosmetic products;

FIG. 7b shows a front section view of a ring gear of the applicator device for cosmetic products;

FIG. 7c shows a top view of a ring gear of the applicator device for cosmetic products;

FIG. 8 shows an applicator device for cosmetic products in section, as in FIG. 1, but after a partial use of the product.

Referring to FIG. 1 the applicator device 10 for cosmetic products is comprehensive of a tubular container 12, inside of which the cosmetic product is placed having, on one side, a separable closing cap 11 and, on the other side, a closing element 13.

The closing cap 11 has an inside diameter which corresponds to the outside diameter of the tubular container 12 on which it is placed. In addition, the tubular container 12, in the point of contact with the closing cap 11 has suitable means 25 to maintain an airtight closing. In particular, the means 25 comprise recessings placed on the entire external circumference of the tubular container 12 and reliefs located on the inner wall of the closing cap 11, which cooperate with each other.

On the fore end of the tubular container 12 a first cylindrical sleeve 14 is placed having a central hole 17 in direction of its axis. Connected to the first sleeve 14 a second cylindrical sleeve 15 is placed, as it can also be seen from FIGS. 2a and 2b, having a central disc 18, with diameter smaller than the one of the second sleeve 15, connected with it through the rods 19. The central disc 18 is connected, through the rods 19, with the second sleeve 15, so as to form a cupola structure having the convex part towards the inside of the container. The cosmetic product can flow into the space between the second sleeve 15 and the central disc 18.

Above the sleeves 14 and 15 an output sleeve 16 comprehensive of a plurality of holes 24 is placed, as it can also be seen from FIGS. 3a and 3b. The holes, square in shape, have dimensions comprised between 1×1 milimeter and 2.5×2.5 milimeters. The shape of the holes can also be round and their number varies when varying their dimensions.

The external top part of the sleeve 16 has undergone the flocking treatment. The flocking is a deposition of short textile fibers on a support previously treated with an adhesive. The flocking is carried out with a typically electrostatic process which uniformly distributes the flock microfibers on the piece, by giving to it the characteristics of a pleasantly velvety product.

The closing element 13, as it can be also seen from FIGS. 4a and 4b, has a cylindrical shape, and by moving toward the center of it, a cylindrical empty space 30 concentric to the closing element 13 is created, and therefore a central pin 31, substantially higher than the external part of the closing element 13, and having fins 32 projecting on the outside for its entire length. Inside the closing element 13, in the empty cylindrical space 30, two projections 35 for its entire height are present, opposite to each other, and also two partial reductions of diameter which form two longitudinal planes 36, opposite to each other.

Inside the closing element 13 there is a tubular element 20, as it can be seen also from FIGS. 5a and 5b, having a height substantially equal to the one of the central pin 31 of the closing element 13. In the bottom part of the tubular element 20, recesses 33 are predisposed into which the fins 32, of the central pin 31, can be inserted.

Outside the tubular element 20 a threading 34 is predisposed.

Between the closing element 13 and the tubular element 20 a round structure 21 empty on its inside, and substantially with height equal to the external part of the closing element 13 is inserted, as it can also be seen from FIGS. 6a and 6b. The round structure 21 has along its entire height, two flat portions 40 and 41 opposite to each other, and two recesses 43 located on an axis perpendicular to the axis of conjunction of the plane portions 40 and 41. The recesses 43 cooperate with the two projections 35 of the closing element 13.

At the top of the round structure 21, along the circumference, several equally distanced teeth 42 are placed.

Above the closing element 13 and the round structure 21 a ring gear 22 is placed, as it can also be seen from FIGS. 7a, 7b and 7c.

On its inside there is a threading 50 which cooperates with the threading 34 of the tubular element 20. On its outside there are projections 51 in order to allow its locking inside the tubular container 12. Along the circumference of its bottom surface a plurality of equally distance teeth 52 are placed which are suitable to cooperate with the teeth 42 of the round structure 21.

Above the ring gear 22 a piston 23 is placed that is integral with the tubular element 20.

For the operation of the applicator device of cosmetic products 10, after having removed the closing cap 11, it is necessary to make the closing element 13 rotate clockwise as regards the tubular container 12. The closing element 13 is integral with the tubular element 20, owing to the cooperation of the projecting fins 32 with the recesses 33. The tubular container 12 is integral also with the round structure 21, owing to the flat portions 36 and 40, and to the projections 35 and the recesses 43.

By rotating such elements, the threading 34 cooperates with the threading 50 and makes the tubular element 20 slide forward, with the annexed piston 23, as it can be seen in FIG. 8. In this way, the cosmetic material is thrust toward the hole 17 of the first sleeve 14, therefore toward the space external to the central disc 18 and then toward the holes 24 of the output sleeve 16.

The teeth 42 and 52, have right-angle triangle shape, and in particular the teeth 42 have the inclined wall oriented toward the right and the teeth 52 have the inclined wall oriented toward the left. They cooperate with each other so that the clockwise rotation of the closing element 13 as regards the tubular container 12, and therefore the advancement of the cosmetic product, is allowed but not viceversa.

Inside the tubular container 12 the creamy cosmetic product is thus placed. By the term of creamy cosmetic product, of fluid or semifluid type, a substance having a low viscosity at room temperature is meant.

1. Applicator device for cosmetic products comprising: a container containing a cosmetic product; means for the advancement of said cosmetic product toward a first end of said container, placed at a second end of said container; a cap suitable to close said first end of said container; characterised in that said first end comprises a grid, from which said cosmetic product outflows, whose external surface has undergone a flocking process.

2. Applicator device for cosmetic products according to claim 1 characterised in that said cosmetic product is fluid or semi-fluid.

3. Applicator device for cosmetic products according to claim 1 characterised in that said cap is airtight.

4. Applicator device for cosmetic products according to claim 1 characterised in that said means for the advancement, comprise a toothed fixed element and a toothed mobile element coupled in such a way so as to allow the advancement of a thrust piston of said cosmetic product and it prohibits the backing of said thrust piston.
